(19) United States
(12) Patent Application Publication
(10) Pub. No.: US 2026/0116482 A1
(43) Pub. Date: Apr. 30, 2026

(54) BUSHING WITH SLEEVE

(71) Applicant: Caterpillar Inc., Peoria, IL (US)

(72) Inventor: Eric James Johannsen, Washington, IL (US)

(73) Assignee: Caterpillar Inc., Peoria, IL (US)

(21) Appl. No.: 18/933,601

(22) Filed: Oct. 31, 2024

(51) Int. Cl. B62D 55/21

(52) U.S. Cl. CPC B62D 55/21

(57) ABSTRACT

Sleeves that can be disposed on either end of a bushing to improve the wear characteristics and usable lifetime of the bushing is disclosed. During the use of the bushing, such as when a machine including the bushing is operated, the sleeves may be in primary contact with abrasive elements (e.g., other parts of the machine, dirt, rock, etc.) and wear, while the underlying bushing is protected, at least in part, from wear and tear. The sleeves may include a bulk material, such as steel, with a hard coating thereon, such as hard chromium, tungsten carbide, or the like. The hard coating may be formed by any variety of processes, such as electroplating, plasma deposition, thermal deposition, or the like. In some cases, the sleeves, after being worn from use, may be replaced or refurbished to further extend the lifetime of the bushing.

### TECHNICAL FIELD

The present disclosure relates to a track bushing. More specifically, the present disclosure relates to a protective sleeve for track bushings to achieve improved wear life and toughness of the bushing.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as those frequently found in the industries identified above. Specifically, rather than rolling across a work surface on wheels, track-type machines utilize one or more track assemblies that include an endless loop of coupled track links defining outer surfaces, which support ground-engaging track shoes, and inner surfaces that travel about one or more rotatable track-engaging elements, such as, drive sprockets, idlers, tensioners, and rollers, for example.

Typical track chain assembly designs include a track pin either fixedly or rotatably connected to a pair of chain links and a bushing rotatably positioned between the links and about the track pin. Such track chain assemblies can operate in extremely adverse environments in which track joints may be exposed to various abrasive mixtures of water, dirt, sand, rock or other mineral or chemical elements. The bearing interface between a track pin and the bushing can encounter high contact stresses which lead to galling failure. Galling is a principal failure mode for track chain assemblies and can limit the life of track chain assemblies in many applications. Additionally, operation of track chain assemblies can wear out the components of the track chain, such as the bushings.

During operation, the track bushing may experience excessive loading. Different surfaces of the track bushing, for example, an inner diameter, end ring surfaces, and so on may require abrasion resistance with increased strength and toughness to endure loads that may be imposed on the track bushing. Additionally, the production of the track bushing may be a time consuming, laborious, and costly process. Further still, the final bushing may fail to provide sufficient war resistance and toughness when produced by conventional methods.

As an example of producing bushings, U.S. Pat. No. 8,684,475 (hereinafter referred to as the '475 reference) describes a metallurgically bonded wear-resistant coating for undercarriage components. However, the coatings of the '475 reference require significant processing of the undercarriage components, resulting in additional costs of the undercarriage components. Furthermore, by putting the metallurgically bonded wear-resistant coating directly onto the undercarriage component, a significant level of dimensional control is required and there may be limited ability to rework and/or refurbish the coating on the undercarriage components.

Examples of the present disclosure are directed toward overcoming the deficiencies described above.

### SUMMARY

In an example of the present disclosure, a track chain assembly includes a bushing having a substantially annular shape with an outer surface and an inner surface opposing the outer surface and defining a bore of the bushing, the bushing extending from a first end ring to an opposing second end ring. The track chain assembly further includes a sleeve having an insert and a ring portion disposed substantially perpendicularly to the insert, the ring portion having an inner ring surface and an outer ring surface opposing the inner ring surface. The sleeve has a coating over a bulk region and the sleeve is disposed on the bushing such that the insert of the sleeve is in contact with the inner surface of the bushing and the inner ring surface of the sleeve is in contact with at least one of the first end ring or the second end ring.

In another example of the present disclosure, a method includes forming a bushing having a substantially annular shape with an outer surface and an inner surface opposing the outer surface and defining a bore of the bushing, the bushing extending from a first end ring to an opposing second end ring. The method further includes forming a rough sleeve having an insert and a ring portion disposed substantially perpendicularly to the insert, depositing a coating onto the rough sleeve to form a sleeve, and inserting the sleeve into the bore of the bushing, such that the insert is in contact with a portion of the inner surface of the bushing and the ring portion of the sleeve is in contact with at least one of the first end ring or the second end ring of the bushing.

In yet another example of the present disclosure, a machine includes a bushing having a substantially annular shape with an outer surface and an inner surface opposing the outer surface and defining a bore of the bushing, the bushing extending from a first end ring to an opposing second end ring. The machine further includes a first sleeve having a first insert and a first ring portion disposed substantially perpendicularly to the first insert, the first ring portion having a first inner ring surface and a first outer ring surface opposing the first inner ring surface and a second sleeve having a second insert and a second ring portion disposed substantially perpendicularly to the second insert, the second ring portion having a second inner ring surface and a second outer ring surface opposing the second inner ring surface. The first sleeve is disposed on the bushing such that the first insert of the first sleeve is in contact with the inner surface of the bushing and the first inner ring surface of the first sleeve is in contact with the first end ring. The second sleeve is disposed on the bushing such that the second insert of the second sleeve is in contact with the inner surface of the bushing and the second inner ring surface of the second sleeve is in contact with the second end ring.

### BRIEF DESCRIPTION OF DRAWINGS

FIG. 1 is a schematic illustration of an example track-type machine with one or more components formed in accordance with examples of the disclosure.

FIG. 2 is a schematic illustration of an example portion of a track chain assembly for an undercarriage of an example track-type machine as depicted in FIG. 1, according to examples of the disclosure.

FIG. 3 is a schematic illustration of an example bushing of the portion of the track chain depicted in FIG. 2, according to examples of the disclosure.

FIG. 4 is a schematic illustration of an example bushing with sleeves on either end of the bushing, according to examples of the disclosure.

FIG. 5 is a sectional illustration of a bushing with sleeves, according to examples of the disclosure.

FIG. 6 is another sectional illustration of a bushing with sleeves, according to examples of the disclosure.

FIG. 7 is a flow diagram depicting an example method for forming a sleeve for a bushing, according to examples of the disclosure.

FIG. 8 is a flow diagram depicting an example method for providing a sleeve on a bushing, according to examples of the disclosure.

FIG. 9 is a flow diagram depicting an example method for replacing a sleeve on a bushing, according to examples of the disclosure.

### DETAILED DESCRIPTION

Wherever possible, the same reference numbers will be used throughout the drawings to refer to the same or like parts.

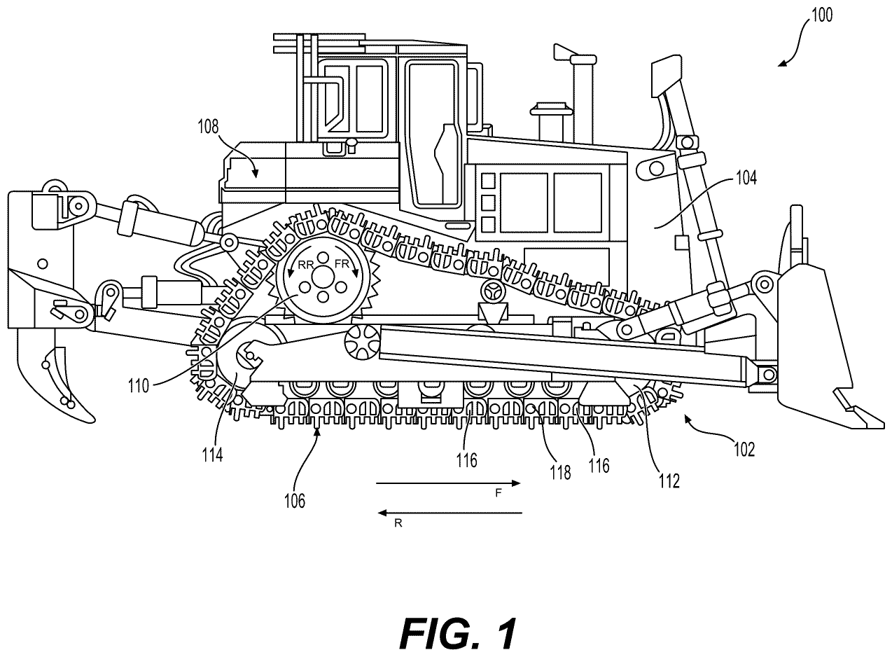

Turning now to the Figures, FIG. 1 is a schematic illustration of an example track-type machine 100 with one or more components formed in accordance with examples of the disclosure. The machine 100 includes a track-type undercarriage 102. The machine 100 may also be referenced herein interchangeably as a track-type machine 100 and/or machine 100. In other cases, the machine 100 may be any suitable machine with the track-type undercarriage 102, such as, a dozer, loader, excavator, tank, backhoe, drilling machine, trencher, or any other on-highway or off-highway vehicle.

The machine 100 includes a frame 104 having a first track chain assembly 106 disposed on a first side 108 thereof, and a second track chain assembly (not shown) disposed on a second side (not shown) thereof. The second side is in opposing relationship to the first side 108. Together, the track assemblies are adapted to engage the ground, or other surface, to propel the machine 100 in a backward and/or forward direction.

It should be appreciated that the track assemblies of the machine 100 may be similar and, further, may represent mirror images of one another. As such, only the first track chain assembly 106 will be described herein. It should be understood that the description of the first track chain assembly 106 may be applicable to the second track chain assembly, as well. Other examples, in accordance with the disclosure, may include more than two track chain assemblies. Thus, the apparatus, systems, and methods, as disclosed herein, apply to any suitable track-type machine, or variations thereof. Additionally, the disclosed components of the track-type machine 100 and the mechanism of formation thereof, as discussed herein, may also apply to other systems, such as non-track type machines and/or other mechanical systems.

With continuing reference to FIG. 1, the first track chain assembly 106 extends about a plurality of rolling elements such as a drive sprocket 110, a front idler 112, a rear idler 114, and a plurality of track rollers 116. The track chain assembly 160 includes a plurality of ground-engaging track shoes 170 for engaging the ground, or other surface, and propelling the machine 100.

During typical operation of the undercarriage 102, the drive sprocket 110 is driven in a forward rotational direction FR to drive the track chain assembly 106, and thus the machine 100, in a forward direction F, and in a reverse rotational direction RR to drive the track chain assembly 106, and thus the machine 100, in a reverse direction R. The drive sprockets 110 of the undercarriage 102 can be independently operated to turn the machine 100.

The undercarriage 102 and track chain assembly 106 may include a variety of other components, as described herein. Due to the harsh operating environments and the loads put on various components of the track chain assembly, it is desirable to improve material properties of the various components of the track chain assembly 106 to improve the usable lifetime of those components.

While the machine 100 is illustrated in the context of a track-type machine, it should be appreciated that the present disclosure is not thereby limited, and that a wide variety of other machines having tracks are also contemplated within the present context. For example, in other examples, the track chain assembly 106 can be included in a conveyor system, as a track for transmitting torque between rotating elements, or in any other application known to those skilled in the art. Additionally, machines without tracks may include components, as disclosed herein.

According to examples of the disclosure, various components of the machine 100 and its track chain assembly 106 may be formed in manner that improves their wear resistance, while maintaining and/or improving their overall toughness. The mechanisms as disclosed herein may apply to any variety of the track chain assembly components disclosed herein, to increase the effective surface hardness of those components, while maintaining relatively high levels of toughness in those components to provide improved surface wear resistance, reduced galling between parts, and high component lifetimes.

The track chain assembly 106 may include bushings 118 therein. The bushings may be integrated within the load bearing portions of the track chain assembly 106. Therefore, the bushings 118 may be subject to heavy loads and/or pressure during operation of the machine 100. The loads on the bushing 118 may result in a variety of concerns, including rapid wear and tear, galling, and/or breakage. According to examples of the disclosure, a sleeve may be formed and disposed on end(s) of the bushing(s) 118. The sleeves may have a hard coating that provides for a relatively high level of wear protection of the bushing, while not substantially changing the bulk material properties of the bushing 118 itself. Thus, a high level of outer hardness of the sleeves may result in diminished wear and/or galling issues, while the bulk bushing 118 may maintain its toughness. In some cases, the sleeves may further be replaceable after they are worn, resulting in extended lifetimes of the bushing 118 itself.

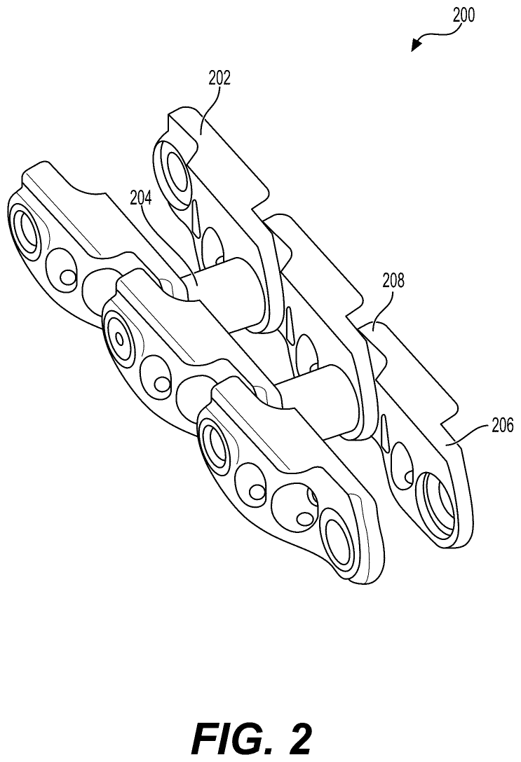

FIG. 2 is a schematic illustration of an example portion 200 of a track chain assembly 106 for an undercarriage 102 of the example track-type machine 100 as depicted in FIG. 1, according to examples of the disclosure. As discussed above, when operated, a drive sprocket 110 of the track-type machine 100 may rotate the track assembly 106 about one or more idlers or other guiding components, such as the front idler 112, a rear idler 114, and a plurality of track rollers 116, to facilitate movement of the machine 100.

The track assembly 106 may further include a series of links 202 that may be joined to each other by laterally disposed track bushings 204. The bushing 204 may be an example of bushing 118, as depicted in FIG. 1. As shown, the links 202 may be offset links. That is, each of the links 202 may have an inwardly offset end 206 and an outwardly offset end 208. The inwardly offset end 206 of each of the links 202 are joined to the respective outwardly offset end 208 of each of the adjacent links. In addition, the inwardly offset end 206 of each of the links 202 may be joined to the inwardly offset end 206 of the opposing link, and the outwardly offset end 208 of each of the links 202 may be joined to the outwardly offset end 208 of the opposing link by the track bushing 204. It should be understood, however, that links 202 need not be offset links. Rather, in some cases, the links 202 may include inner links and outer links. In such cases, both ends of each opposing pair of inner links are positioned between ends of opposing outer links, as is known in the art.

The present disclosure relates to the formation, production, and/or manufacture of the track bushing 204 and the components and systems in which the track bushing is used, such as the track chain assembly 106 and/or machine 100. Additionally, the mechanisms for formation of the track bushing 204 may be applied to other components, such as other components of the track chain assembly 106 and/or machine 100.

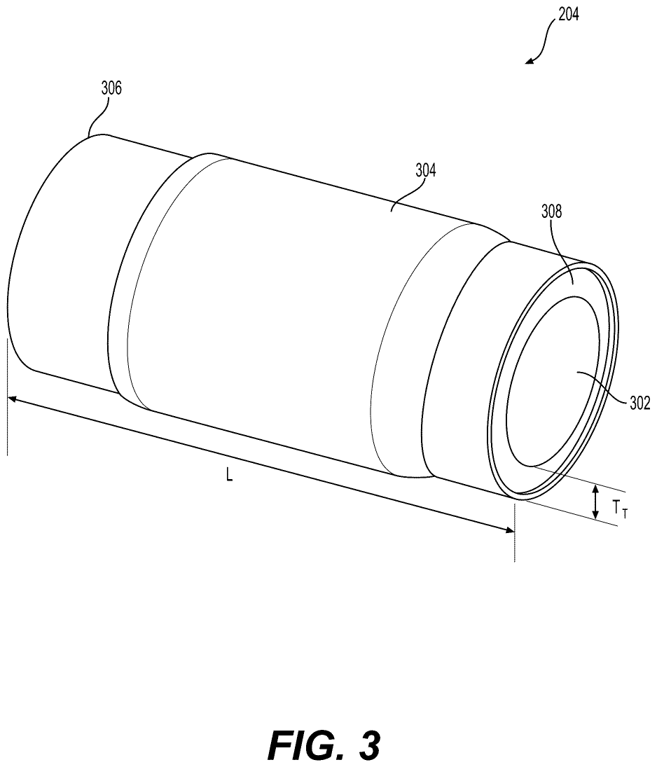

FIG. 3 is a schematic illustration of an example bushing 204 of the portion of the track chain depicted in FIG. 2, according to examples of the disclosure. The track bushing 204 may have a generally hollow cylindrical shape including an inner surface 302 and an outer surface 304 defining a thickness “T_{T}” of the track bushing 204 therebetween. As shown, the inner surface 302 and the outer surface 304 may have a curvature to define the round shape of the track bushing 204. The track bushing 204 also has a first end ring 306 and a second end ring 308 defining a length (L) of the track bushing 204.

The shape and dimensions of the track bushing 204 may vary based on the application. For example, larger track chain assemblies 106 may include track bushings 204 of larger size than for smaller sized track chain assemblies 106. The thickness of various portions (e.g., hardened surface layers, softer core portions, etc.) of the track bushing 204 may also vary according to the application of the track bushing 204.

The track bushing 204, according to examples of the disclosure, may be made of high carbon steel with additional processing as disclosed herein. The carbon content of the track bushing 204, as formed and prior to any hardening and/or tempering treatments, may be greater than approximately 0.8% carbon by weight. In other examples, the track bushing 204, as formed and prior to any hardening and/or tempering treatments, may be greater than approximately 0.9% carbon by weight. For example, the track bushing may be formed from 52100 steel with a carbon content of greater than 0.9% by weight, such as between approximately 0.95% and 1.1% carbon by weight. In some examples, the carbon content of the track bushing 204, as formed and prior to any hardening and/or tempering treatments, may be greater than approximately 1.1% carbon by weight. Other elements present in the steel may include, but is not limited to, cobalt (Co), molybdenum (Mo), nickel (Ni), titanium (Ti), tungsten (W), niobium (Nb), vanadium (V), combinations thereof, or the like.

In alternative cases, the track bushing 204 may be made of high carbon steel with additional processing as disclosed herein. In these examples, the carbon content of the track bushing 204 may lie approximately between 0.4% and 0.8% carbon by weight. In some cases, the track bushing 204, as formed and prior to any hardening and/or tempering treatments, may be between approximately 0.6% and 0.8% carbon by weight. In other cases, lower carbon steel with carbon concentration below about 0.4% may be used to form the bushing 204.

The track bushing 204 steel may further include other elements therein, such as manganese (Mn), phosphorus (P), sulfur(S), silicon (Si), chromium, and/or other materials. For example, the steel, prior to any hardening and/or tempering treatments, may include between approximately 0.1% and 0.6% Mn by weight, between approximately 0% and 0.1% P by weight, between approximately 0% and 0.1% S by weight, between approximately 0.1% and 0.5% Si by weight, and/or between approximately 0.6% and 3% Cr by weight.

The track bushing 204 steel, during rough bushing formation, may be spheroidized cementite crystal structure. The spherodoidized cementite structure may be soft and ductile, allowing for easier formation of the track bushing 204. For example, if the starting high-carbon steel is not in a spheroidized cementite structure, then a spheroidizing process may be performed. In some cases, the spheroidizing process may be conducted at an under the carbon-steel eutectic temperature for a multi-hour anneal. For example, the steel may be held at 700° C. for 30 hours to spheroidize the steel prior to rough forming the track bushing 204.

According to some examples of the disclosure, the track bushing 204 after formation, may be subject to various thermal treatments, such as a direct hardening process, followed by an induction hardening process on the inner surface 302 or inner diameter (ID) of the track bushing 204. This direct hardening process followed by the induction hardening process may lead to formation of hardened steel at a region near both the outer surface 304 and the inner surface 302 of the track bushing 204, while a core region may be softer and more ductile, leading to improved wear resistance and toughness. Thus, the outer portions, such as near the inner surface 302 and near the outer surface 304 of the track bushing 204 may have a mostly martensitic and/or austenitic structure, while the inner portions of the track bushing 204, farther away from the inner surface 302 and the outer surface 304 may have a mostly cementitic crystal structure.

In some cases, T_{T} may be in the range of about 5 mm to about 25 mm. In other cases, T_{T} may be in the range of about 7 mm to about 20 mm. In still other cases, T_{T} may be in the range of about 10 mm to about 15 mm. In some cases, L may be in the range of about 75 mm to about 500 mm. In other cases, L may be in the range of about 100 mm to about 300 mm. In yet other cases, L may be in the range of about 150 mm to about 250 mm. The bore hole of the bushing may have a diameter in the range of about 25 mm to about 150 mm. In other cases, the bore hole of the bushing may have a diameter in the range of about 35 mm to about 100 mm. In yet other cases, the bore hole of the bushing may have a diameter in the range of about 50 mm to about 75 mm.

In some cases, the bushing may be formed and then subject to various treatments, such as carburizing, nitriding, and/or hard facing. These processes may be optional and may be performed before placing a sleeve over the end of the bushing 204. In a carburizing process, the bushing 204 may be subject to a high temperature in a carbon rich ambient (e.g., using carbon monoxide, carbon dioxide, etc.) to diffuse carbon into the surfaces 302, 304 and/or the end rings 306, 308 of the bushing 204. The diffusion depth of the carbon may be a few millimeters into the surface, creating a surface region with greater carbon concentration than the remaining bulk region of the bushing 204. The greater carbon concentration at the surfaces may result in a harder surface region of the bushing 204 and a softer bulk region of the bushing 204. In a nitriding process, the bushing 204 may be subject to a high temperature in a nitrogen rich ambient (e.g., using ammonia, nitrous oxides, etc.) to diffuse nitrogen into the surfaces 302, 304 and/or the end rings 306, 308 of the bushing 204. The diffusion depth of the nitrogen may be a few millimeters into the surface, creating a surface region with greater nitrogen concentration than the remaining bulk region of the bushing 204. The greater nitrogen concentration at the surfaces may result in a harder surface region of the bushing 204 and a softer bulk region of the bushing 204. Hard facing may entail welding, or otherwise disposing relatively hard (e.g., harder than the steel of the bushing 204) onto the surfaces 302, 304 and/or the end rings 306, 308 of the bushing 204.

According to examples of the disclosure, once the bushing 204 is formed, a sleeve may be disposed at one or both ends of the bushing. For example, the sleeve, after insertion, may cover a portion of the inner surface 302, at least a portion of end rings 306, 308, and/or a portion of outer surface 304. The sleeve may be formed with a base material, such as steel and have a hard coating thereon. The hard coating may impart relatively high wear resistance to the bushing 204, while the bushing maintains its own material and/or mechanical properties, separate from the sleeve(s).

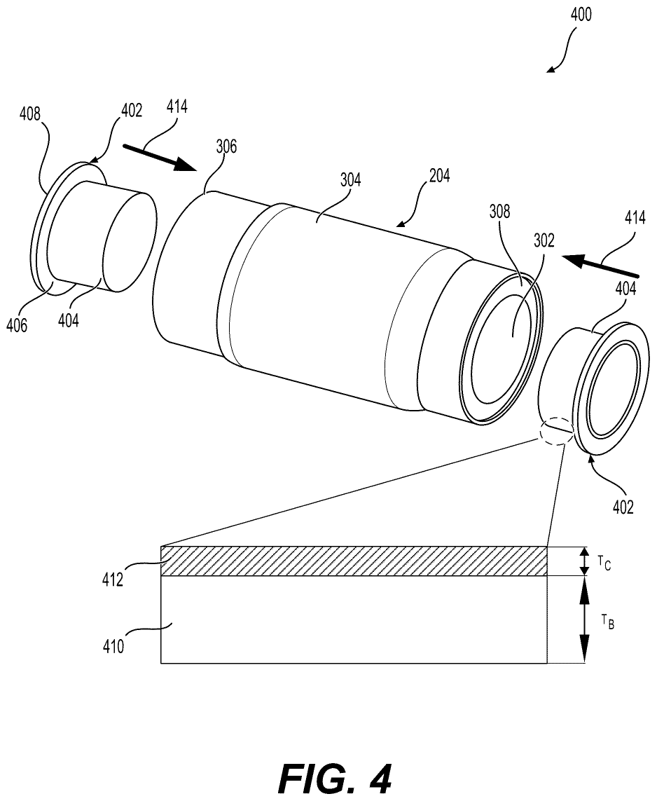

FIG. 4 is a schematic illustration of an example bushing 204 with sleeves 402 on either end of the bushing, according to examples of the disclosure. The sleeves 402 provide protection to the bushing, when provided on either end of the bushing 204. When the machine 100 and the track chain assembly 106 are operated, the sleeves 402 encounter the greatest wear and tear, such that there is a diminished level of wear and tear on the surfaces 302, 304 and/or the end rings 306, 308 of the bushing 204. In this way, the sleeves 402 may be thought of as sacrificial to protect the underlying bushing 204.

As shown, the sleeves 402 may include an insert 404, an inner ring face 406, and an outer ring face 408. The insert 404 may be substantially perpendicular to the inner ring face 406 and the outer ring face 408. The sleeve 402 may be formed from a bulk material (e.g., steel, iron, etc.) to form a bulk portion 410 with a coating layer 412 (e.g., hard chromium, tungsten carbide (WC), etc.) over the bulk portion 410. The sleeves 402, once formed, may be provided onto the bushing 204 by inserting the insert 404 of the sleeves 402 into the bore hole of the bushing 204, as depicted by arrows 414. Both the sleeves 402 and the bushing 204 may be substantially annular shapes.

When the sleeves 402 are inserted within the bushing 204, the insert 404 may be inserted into the bore defined by inner surface 302 of the bushing 204. In some cases, the inserts 404 of the sleeves 402 may be in contact with a portion of the inner surface 302 proximal to the end rings 306, 308 of the bushing 204. When inserted, the inner ring faces 406 of the sleeves 402 may be in close proximity and/or in contact with the end rings 306, 308 of the bushing 204. As a result, the end rings 306, 308 may not be exposed to abrasive elements that may lead to their wear. Rather, the outer ring face 408 of the sleeve 402 may be exposed to abrasive and/or wear imparting elements during the use of the machine 100. Additionally, a portion of the inner surface 302 of the bushing 204 may be protected by the insert 404 of the bushing 204. In some cases, the sleeves may include an additional portion (not shown) that overlays a portion of the outer surface 304 of the bushing 204. The additional portion may extend substantially parallel to the insert 404 and lie substantially perpendicular to the inner ring face 406 and the outer ring face 408.

The sleeves 402 may be disposed onto the bushing using any variety of mechanisms and/or elements to hold the sleeves 402 in place. In some cases, press fitting may be used to press fit the sleeves 402 onto the bushing 204. In these cases, the sleeves may be dimensionally controlled (e.g., the diameter of the insert 404) such that when press fit into the bushing 204, there is enough frictional hold to keep the sleeves 402 securely held within the bushing 204. In other cases, brazing, soldering, and/or welding may be used to hold the sleeves 402 in place within the bushing 204. For example, the insert 404 and/or the inner ring surface 406 may be brazed within the bushing 204 using any suitable material, such as nickel, tin, zinc, or the like. In yet other cases, epoxies and/or glues may be used to hold the sleeves 402 within the bushing 204.

The sleeve 402 may be manufactured by first forming a rough sleeve using any suitable material, such as steel. Rough sleeve, as used herein, refers to the formation of the sleeve with the steel starting material, prior to any subsequent thermal treatments, hardening, tempering, and/or coating, or the like. In some cases, the steel may be medium carbon steel. In other cases, low carbon steel may be used to form the rough sleeve. In still other cases, high carbon steel may be used to form the rough sleeve. For example, high carbon steel that has cementite structure may be more easily machined than hardened carbon steel.

This form of the steel or iron use to fabricate the rough sleeve may be relatively soft and ductile and is, therefore, amenable to machining and may provide for a high level of toughness of the finished sleeve 402. Formation of the rough sleeve may include any variety of machining techniques suitable for forming the insert 404 and/or the inner ring surface 406 and/or the outer ring surface 408. For example, any type of shaping, turning, milling, drilling, grinding, and/or other machining techniques may be used to form the rough valve component. The bulk portion 410 may be of any suitable thickness. For example, the bulk portion 10 may have a thickness (T_{B}) range of about 1 mm to about 15 mm. In other cases, T_{B} may be in the range of about 5 mm to about 10 mm.

After forming the rough sleeve, the rough sleeve may be subject to a hardening process, such as direct hardening, to form a hardened sleeve prior to applying the coating 412. This direct hardening may be performed in any suitable furnace, such as an induction furnace or a gas furnace. In some cases, this direct hardening process may be a batch process, where more than one rough sleeve and/or other components of the machine 100 may be hardened simultaneously. After performing the furnace process, the rough sleeve may be quenched, such as in oil, water, or air. An optional tempering process may be performed after the hardening process. After the hardening process, the entirety of the rough sleeve may have a hardened martensitic, austenitic, and/or bainite structure. In other words, the rough sleeve, at this point, may be substantially uniformly hardened as a hardened sleeve.

In some cases, the rough sleeve may be subject to carburizing, nitriding, and/or hard facing. The aforementioned processes may form a hard casing (e.g., with a softer bulk portion) on the surfaces of the sleeve 402. In some cases, the hard casing may serve as the coating 412 of the sleeve 402. In other cases, the coating 412 may be disposed, as disclosed herein, over any hard casing that is formed on the rough sleeve. In yet other cases, a casing may not be formed on the sleeves 402, such that the material composition, hardness, and/or stress profile may be relatively uniform throughout the rough sleeve, and the coating 412 may be deposited over a hardened sleeve, as disclosed herein.

In some cases, the hardened sleeves (e.g., rough sleeves subject to thermal treatments) may have hardness in the range of about 39 Rockwell Hardness Scale C (HRC) to about 64 HRC prior to depositing the coating 412. In other cases, the hardened sleeves may have hardness in the range of about 45 HRC to about 62 HRC prior to depositing the coating 412. In yet other cases, the hardened sleeves may have hardness in the range of about 48 HRC to about 60 HRC prior to depositing the coating 412.

The coating 412, as deposited over the bulk portion 410, may be of any suitable composition, thickness, hardness, and/or uniformity. In examples of the disclosure, the coating 412 may have a hardness that exceeds the hardness of the bulk portion 410. Additionally, in some examples of the disclosure, the coating 412 may have thickness (T_{C}) in the range of about 3 microns (μm) to about 200 μm. The coating may be deposited over the bulk portion 410 using any suitable deposition technique including, but not limited to, electroplating, electroless plating, plasma deposition, high velocity air fuel (HVAF) process, high velocity oxygen fuel (HVOF) process, physical vapor deposition (PVD), evaporation process, sputtering process, chemical vapor deposition (CVD), sol-gel process, dip coating process, combinations thereof, or the like.

In some examples of the disclosure, the coating 412 may be provided using trivalent chromium electroplating on the bulk portion 410 in a thickness (T_{C}) range of about 3 μm to about 50 μm. In other cases, the coating thickness range may be between about 5 μm to about 40 μm. In yet other cases, the coating thickness range may be between about 8 μm to about 35 μm. In still other cases, the coating thickness range may be between about 10 μm to about 30 μm. In yet further cases, the coating thickness range may be between about 13 μm to about 27 μm. In still further cases, the coating thickness range may be between about 15 μm to about 25 μm. For example, in some cases, the thickness of the coating may be about 20 μm. Although, electroplated trivalent Cr is discussed herein, it should be understood that hexavalent Cr may be used in place of trivalent Cr for the coating 412.

In some cases, trivalent Cr may be plated on top of an electroplated layer of Ni electroplated over the bulk portion 410. The Ni electroplated coating on the bulk portion 410 and under the Cr coating may have a thickness in the range of about 1 μm to about 75 μm. In other cases, the Ni coating thickness range may be between about 3 μm to about 65 μm. In yet other cases, the Ni coating thickness range may be between about 5 μm to about 60 μm. In still other cases, the Ni coating thickness range may be between about 10 μm to about 50 μm. In yet further cases, the Ni coating thickness range may be between about 13 μm to about 40 μm. In still further cases, the Ni coating thickness range may be between about 15 μm to about 30 μm. For example, in some cases, the thickness of the Ni coating may be about 25 μm.

The total thickness of a bilayer coating with trivalent Cr film over a Ni film may be in a thickness (T_{C}) range of about 4 μm to about 125 μm. In other cases, the bilayer coating thickness (T_{C}) range may be between about 8 μm to about 105 μm. In yet other cases, the bilayer coating thickness range may be between about 13 μm to about 95 μm. In still other cases, the Ni coating thickness range may be between about 20 μm to about 80 μm. In yet further cases, the Ni coating thickness range may be between about 26 μm to about 67 μm. In still further cases, the Ni coating thickness range may be between about 30 μm to about 55 μm. For example, in some cases, the thickness of the Ni coating may be about 45 μm. In many cases, the combined thickness of the bilayer coating of Cr over Ni may be less than 100 μm, less than 75 μm, or even less than 50 μm. The relatively thin protective layer(s) can be electroplated relatively quickly and provide similar or improved protection of the sleeve 402 compared to other protective coatings.

In some cases, the bilayer coating (a Cr layer over a Ni layer) may have a uniformity of 15 μm or less over the entirety of the surface of the sleeve 402. In other cases, the bilayer coating may have a uniformity of 10 μm or less over the entirety of the surface of the sleeve 402. In yet other cases, the bilayer coating may have a uniformity of 8 μm or less over the entirety of the surface of the sleeve 402. In still other cases, the bilayer coating may have a uniformity of 5 μm or less over the entirety of the surface of the sleeve 402.

The hardness of the Cr layer as coating 412 may be in a range of about 800 Vickers to about 1800 Vickers. In some cases, the coating 412 as Cr may have a hardness in the range of about 1100 Vickers to about 1500 Vickers. In yet other cases, the coating 412 as Cr may have a hardness in the range of about 1200 Vickers to about 1400 Vickers. If the bulk portion 410 is coated with coating 412, such as the bilayer coating of Cr over Ni or just Cr, then there will be reduced wear and tear of the sleeves 402, and therefore, reduced wear and tear of the bushing 204.

In other example cases, the coating 412 may be formed by any suitable thermal spray process, such as a high velocity air fuel (HVAF) process. The HVAF process, in example embodiments, may result in minimal increase on the surface temperature of the rough and/or hardened sleeve, leading to relatively reduced levels of distortion and/or warping compared to other coating processes. The HVAF process may also allow relatively high coating speed, as well as high surface adhesion. In examples of the disclosure, the HVAF process may entail ejecting coating powders, along with air and fuel through a nozzle. The fuel, such as pressurized propane, propylene, natural gas, or the like, along with pressurized air may carry the coating powder in its stream, as this mixture is provided through the nozzle. For example, the coating powder may include WC powder for depositing WC as the coating 412. The coating 412 may be deposited on the rough and/or hardened sleeve by rastering a nozzle over the surface of the rough and/or hardened sleeve or rastering the rough and/or hardened sleeve under the nozzle.

In other example embodiments, other processes may be used to form the coating 412, such as high velocity oxygen fuel (HVOF), plasma spray, combinations thereof, or the like. In some examples the coating 412 may include materials other than WC. For example, the coating 412 may include WN, DLC, W, Ta, Ti, Cr₃C₂, vanadium carbide, alumina, alloy steel, ceramic materials, metals, combinations thereof, or the like. In some cases, the coating may further include cobalt (Co) and/or chromium (Cr). For example, the composition of the powder feedstock, as well as the coating 412, may be approximately 86% WC by weight, 10% Co by weight, and 4% Cr by weight. In other cases, the WC content may range from about 50% by weight to about 97% by weight. Although the discussion herein may focus on WC based coatings, it should be understood that any suitable coating 412, such as Cr based, Ni based coatings, chromium carbide (Cr₂C₃) coatings, aluminium oxide (Al₂O₃) coatings, zirconium oxide (ZrO₂) coatings, chromium oxide (Cr₂O₃) coatings, Stellite alloy coatings, high-Cr/Ni stainless steel alloy coatings, Diamalloy 2001 coatings, etc., may be used in accordance with the disclosure herein.

The coating 412 may be provided using HVAF and/or HVOF thermal spray on the bulk portion 410 in a thickness (T_{C}) range of about 15 μm to about 80 μm. In other cases, the coating 412 thickness range may be between about 25 μm to about 60 μm. For example, in some cases, the thickness of the coating 412 may be about 40 μm. The coating may have a hardness of approximately 800 Vickers to about 1400 Vickers. In some cases, the coating may have a hardness in the range of about 1100 Vickers to about 1300 Vickers. In yet other cases, the coating may have a hardness in the range of about 1150 Vickers to about 1250 Vickers.

In still further cases, the coating 412 on the sleeve 402 may be a diamond like carbon (DLC) coating. For example, the DLC coating may be a tetrahedral amorphous carbon (ta-C) type of DLC and/or amorphous A-C: H DLC. In some cases, the coating on the wear sleeve 220 may be metal-doped and/or metalloid-doped DLC (Me-DLC). For example, the coating 412, in some cases, may be tungsten (W)-doped DLC (W-DLC), titanium (Ti)-doped DLC (Ti-DLC), silicon (Si)-doped DLC (Si-DLC), and/or tungsten carbide (WC)-doped DLC (WC-DLC). The coating, as disclosed herein, may be a thin film that may be deposited by any variety of processes, such as physical vapor deposition (PVD) or other vacuum and/or plasma processes. Alternatively, the coating may include any variety of nitrides and/or carbides, such as CrN, TiN, TiAlN, TaN, VC, TiC, WC, TaC, etc.

Regardless of the exact type and stoichiometry of the coating, the outer diameter of the wear sleeve 220, where the coating is disposed, may provide a lower friction surface than if the wear sleeve is not coated. In other words, the coating, as disclosed herein, effectively reduces the coefficient of kinetic friction (μₖ) and/or the coefficient of static friction (μₛ) between the sleeve 402 and any materials with which the sleeve 402 makes contact. Thus, the reduced levels of friction between the parts of the track chain assembly 106 result in reduced friction, heat, and wear of the bushing with the sleeve 400. Additionally, the sleeve 402 with the coating 412 protects the bushing 204 from wear.

In other examples of the disclosure, PVD-enhanced chemical vapor deposition (CVD) and/or reactive sputtering may be used to deposit the Me-DLC film as the coating 412. The hardened and/or rough sleeve may be mounted on a rotating platen that exposes the surfaces of the hardened sleeve to the target within the PVD-enhanced CVD chamber and/or a reactive sputtering chamber. The chamber may have a metal target, such as a W target. The chamber may be powered and electrically biased in such a way that the W target is sputtered while C containing gases C (e.g., C₂H₄, C₂H₆, CH₄, etc.) are flown into the chamber to deposit the DLC. In this way, DLC is deposited by CVD, while sputtered metal (e.g., W, Ti, etc.) dopes the deposited DLC. In yet other examples of the disclosure, a CVD process (e.g., plasma enhanced CVD (PECVD)) may be performed to deposit the coating 412.

It should be understood that the coating 412 may be formed using more than one of the films described herein, as may be deposited by various mechanisms. For example, the coating 412 may include both an electroplated film (e.g., trivalent Cr) and a HVAF deposited film (e.g., WC). In some cases, multiple films with full coverage of the film may provide the coating 412 on the sleeve 402. In other cases, some films may have partial coverage and other films may have full coverage over the surfaces of the sleeve 402. In other words, any combination of films deposited on the bulk portion 410 of the sleeve 402, either deposited on part of the surface of the sleeve 402 and/or fully deposited on the surfaces of the sleeve 402, may serve as the coating 412.

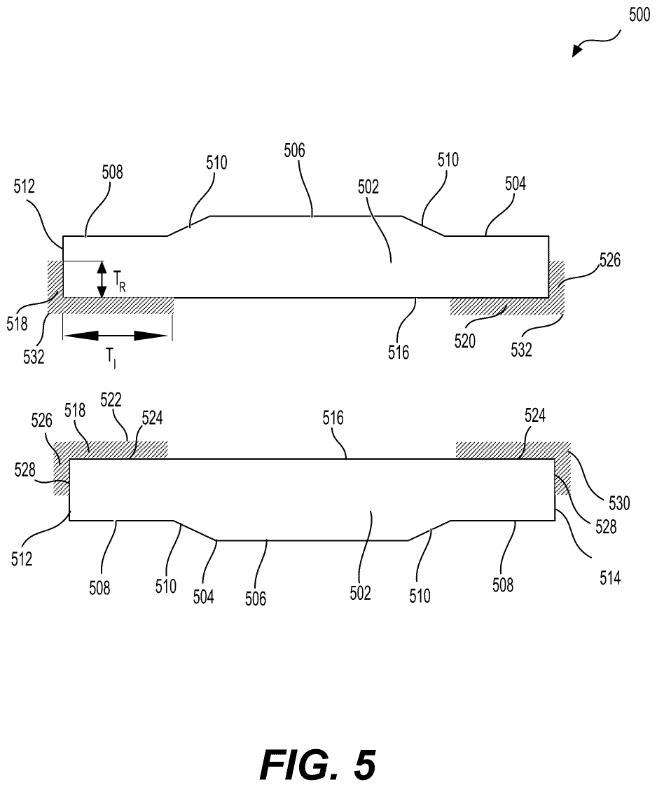

FIG. 5 is a sectional illustration of a bushing with sleeves 500, according to examples of the disclosure. The bushing with sleeves 500, as depicted may be a cross-sectional view (without showing the curved portions of the bushing 204), may be an example of bushing with sleeves 400, where sleeves 402 are disposed on bushing 204. The dimensions and parameter ranges discussed herein are examples and are not meant to be limiting in any way. This example bushing with sleeves 500 cross section may be an illustrative sectioning through the diameter of the track bushing 204, where the exposed face sections of the sectioning is shown, without showing the curved inner surface 302.

The bushing with sleeves 500 includes a bushing 502, which may be substantially similar to bushing 204 of FIG. 2. The bushing 502 may include an outer surface 504, which may be substantially similar to surface 304 of bushing 204. The outer surface 504 may include a protruded flat surface 506, a flat surface 508 on either side of the protruded flat surface 506, and an intermediate surface 510 between the flat surface 508 and the protruded flat surface 506. The bushing may include an end ring 512 on one end and another end ring 514 on the other opposing end. The bushing may further include an inner surface 516. The dimensions of the bushing may be similar to the dimensions discussed in conjunction with the bushing 204 of FIG. 2.

The bushing with sleeves 500 includes sleeve 518, as shown in cross section, when provided onto the bushing 502. The sleeve 518 includes an insert 520, the description of which may be similar to the description of insert 404 of FIG. 4. The insert 520 may include an insert outer surface 522 and an insert inner surface 524, which is in contact with the inner surface 516 of bushing 502. The insert 520 may include a ring 526 with an inner ring surface 528 and an outer ring surface 530. The description of the inner ring surface 528 and the outer ring surface 530 may be substantially similar to the description of the inner ring surface 406 and the outer ring surface 408 of FIG. 4. When the sleeve 518 is provided on the bushing 502, the inner ring surface 528 may be in contact with at least a portion of the end rings 512, 514 of the bushing 502. Where the insert 520 meets with the ring 526, there may be a corner 532. Although the corner 532 is shown as a sharp and/or right angle, it will be understood that the corner 532 may be rounded or beveled. When the bushing with sleeves 500 is in use, such as when the track chain assembly 106 of the machine 100 is operational, abrasive elements (e.g., other components of machine 100, dirt, rock, etc.) may be in contact with the insert outer surface 522 and the outer ring surface 530, thereby protecting surfaces of the bushing 502.

The insertion depth (T_{I}) of the insert 520 may be any suitable depth, such as in the range of about 10 mm to about 100 mm. In other cases, T_{I} may be in the range of about 20 mm to about 75 mm. In yet other cases, T_{I} may be in the range of about 30 mm to about 50 mm. In some cases, the insertion depth may be substantially similar to the length of the flat surface 508. The ring extension (T_{R}) may be in the range of about 2 mm to about 25 mm. In other cases, T_{R} may be in the range of about 4 mm to about 20 mm. In yet other cases, T_{R} may be in the range of about 7 mm to about 15 mm. In some cases, the ring 526 may cover the end rings 512, 514 of the bushing 502 (areal coverage) in a range of about 10% to 100%. In some cases, the ring 526 may cover the end rings 512, 514 of the bushing 502 (areal coverage) in a range of about 30% to 70%.

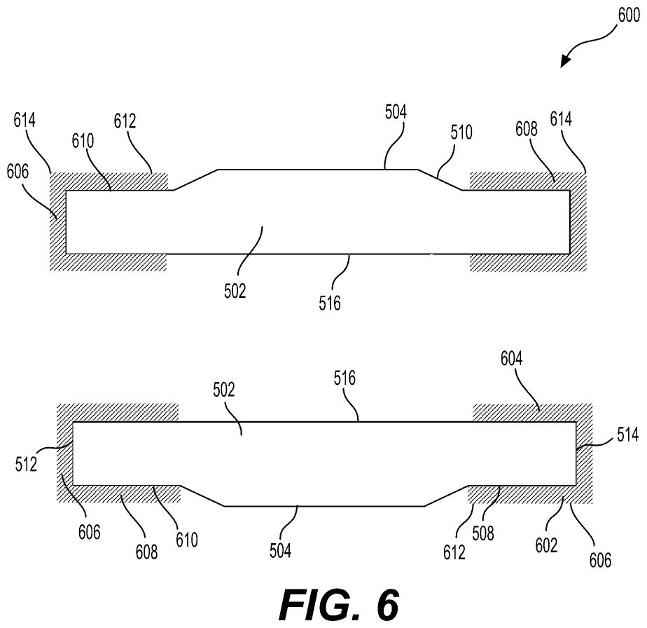

FIG. 6 is another sectional illustration of a bushing with sleeves 600, according to examples of the disclosure. The bushing with sleeves 600 is similar to the bushing with sleeves 500 of FIG. 5, in that the bushing with sleeves 600 includes sleeves 602 that have an insert 604 and a ring 606. However, sleeves 602 also include a wrap portion 608 with inner wrap surface 610 and outer wrap surface 612. Additionally, the ring 606 of sleeve 602 completely cover the end rings 512, 514 of the bushing 502. When the sleeve 602 is disposed on bushing 502, the inner wrap surface 610 of the sleeve 602 may be in contact with the flat surface 508 of the bushing 502. The length of the wrap portion 608 may be substantially similar to the length of the insert 604. In some cases, the wrap portion 608 of the sleeve 602 may substantially cover the flat surface 508 of the bushing 502. The sleeve 600 may include a corner 614 between the ring 606 and the wrap surface 612. Although the corner 614 is shown as a sharp and/or right angle, it will be understood that the corner 614 may be rounded or beveled.

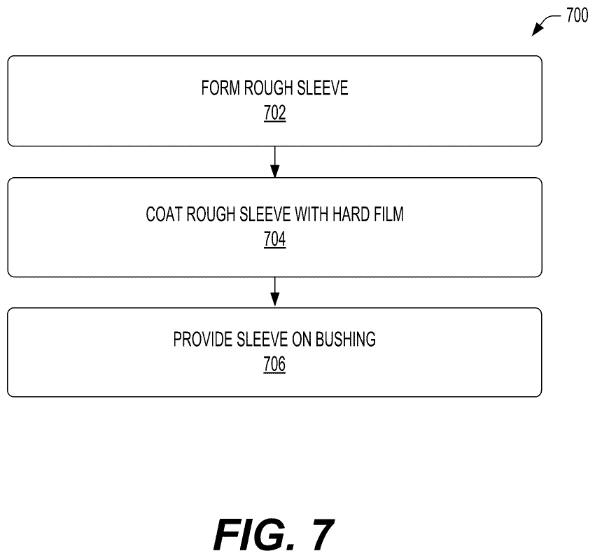

FIG. 7 is a flow diagram depicting another example method 700 for forming the example bushing of FIG. 4, according to examples of the disclosure. The method 700 may be performed in any suitable setting or combination of settings, such as a factory, a foundry, and/or a construction site.

At block 702, the rough sleeve is formed. The rough sleeve may be formed using any one of low carbon steel, medium carbon steel, or high carbon steel. Formation of the sleeve, in this case a rough sleeve, may include any variety of machining techniques suitable for forming the bushing. For example, any type of shaping, turning, milling, drilling, grinding, and/or other machining techniques may be used to form the rough sleeve. In some cases, a soft, compliant steel may be used (e.g., prior to thermal hardening) to allow for ease of machining the rough sleeve.

In some cases, the rough sleeve may be hardened uniformly to a first hardness level. As discussed herein, this may be achieved by a direct hardening process or other similar processes. The direct hardening processing may be performed by heating the rough sleeve to a higher than eutectic temperature. This direct hardening may be performed in any suitable furnace, such as an induction furnace or a gas furnace. In some cases, this direct hardening process may be a batch process, where more than one rough sleeve and/or other components of the machine 100 may be hardened simultaneously.

The furnace process may be performed at any suitable temperature and time. For example, the furnace process may be performed at greater than 800° C. for predetermined time. In some examples, the furnace process may be performed in a temperature range from about 800° C. to about 950° C. for a time range of about 30 minutes to about 3 hours. For example, the furnace heating process of the direct hardening may be performed at 850° C. for 60 minutes. After performing the furnace process, the rough sleeve may be quenched, such as in oil. Alternatively, the quenching process may be in any suitable medium, such as a salt bath, air, and/or water. An optional tempering process may be performed after the hardening process.

After the direct hardening process, the entirety of the hardened rough sleeve may have a hardened martensitic, austenitic, and/or bainite structure. In other words, the rough bushing, at this point, may be substantially uniformly hardened throughout its thickness. As a result of the direct hardening process, the hardness of the entire bushing may be in the range of about 55 HRC to about 62 HRC. For example, the bushing may be approximately 60 HRC after the direct hardening process. In some cases, the rough sleeve may be subject to a carburizing, nitriding, and/or hard facing process to form a hard outer layer (e.g., casing) of the hardened sleeve.

The bushing may optionally be tempered. This tempering process, among other things, may be to relieve the stresses and reduce micro-cracking that may have resulted from an oil quenching process. In some cases, the tempering process may be at a temperature in the range of about 100° C. to about 200° C. for about 30 minutes to about 3 hours. In one example, the tempering process may be at 150° C. for 60 minutes. In some cases, this tempering process may be performed in batch, such as with other components of machine 100, such as other bushings 204. The tempering process may be performed in any suitable furnace or heating chamber, such as an induction furnace and/or gas furnace.

At block 704, the rough sleeve and/or hardened sleeve is coated with a hard film. In some cases, an electroplating process with trivalent chromium may be used. The rough sleeve may be attached to an electrode and immersed into an electroplating bath and current passed through the rough and/or hardened sleeve. The passing of current allows for copper ions in the electroplating bath to reduce and plate the surfaces of the rough sleeve. In some cases, trivalent Cr may be plated on top of an electroplated layer of Ni electroplated over the bulk portion 410. In other cases, hexavalent Cr may be used instead of trivalent Cr. In other cases, other hard films may be coated by electroplating. In yet other cases, the coating 412 may be deposited by electroless plating.

In other example cases, the coating 412 may be formed by any suitable thermal spray process, such as a high velocity air fuel (HVAF) process, high velocity oxygen fuel (HVOF), plasma sprays, or the like. The HVAF and/or HVOF process, in example embodiments, may result in minimal increase on the surface temperature of the rough and/or hardened sleeve, leading to relatively reduced levels of distortion and/or warping compared to other coating processes. The HVAF and/or HVOF process may also allow relatively high coating speed, as well as high surface adhesion. In examples of the disclosure, the HVAF process may entail ejecting coating powders, along with air and fuel through a nozzle. The fuel, such as pressurized propane, propylene, natural gas, or the like, along with pressurized air may carry the coating powder in its stream, as this mixture is provided through the nozzle. For example, the coating powder may include WC powder for depositing WC as the coating 412. The coating 412 may be deposited on the rough and/or hardened sleeve by rastering a nozzle over the surface of the rough and/or hardened sleeve or rastering the rough and/or hardened sleeve under the nozzle.

In some examples the coating 412 deposited by HVAF and/or HVOF may include materials other than WC. For example, the coating 412 may include WN, DLC, W, Ta, Ti, Cr₃C₂, vanadium carbide, alumina, alloy steel, ceramic materials, metals, combinations thereof, or the like. In some cases, the coating may further include cobalt (Co) and/or chromium (Cr). For example, the composition of the powder feedstock, as well as the coating 412, may be approximately 86% WC by weight, 10% Co by weight, and 4% Cr by weight. In other cases, the WC content may range from about 50% by weight to about 97% by weight. Although the discussion herein may focus on WC based coatings, it should be understood that any suitable coating 412, such as Cr based, Ni based coatings, chromium carbide (Cr₂C₃) coatings, aluminium oxide (Al₂O₃) coatings, zirconium oxide (ZrO₂) coatings, chromium oxide (Cr₂O₃) coatings, Stellite alloy coatings, high-Cr/Ni stainless steel alloy coatings, Diamalloy 2001 coatings, etc., may be used in accordance with the disclosure herein.

In still further cases, the coating 412 on the sleeve 402 may be a diamond like carbon (DLC) coating. For example, the DLC coating may be a tetrahedral amorphous carbon (ta-C) type of DLC and/or amorphous A-C: H DLC. In some cases, the coating on the wear sleeve 220 may be metal-doped and/or metalloid-doped DLC (Me-DLC). For example, the coating 412, in some cases, may be tungsten (W)-doped DLC (W-DLC), titanium (Ti)-doped DLC (Ti-DLC), silicon (Si)-doped DLC (Si-DLC), and/or tungsten carbide (WC)-doped DLC (WC-DLC). The coating, as disclosed herein, may be a thin film that may be deposited by any variety of processes, such as physical vapor deposition (PVD), chemical vapor deposition (CVD), reactive sputtering, or other vacuum and/or plasma processes. Alternatively, the coating may include any variety of nitrides and/or carbides, such as CrN, TiN, TiAlN, TaN, VC, TiC, WC, TaC, etc.

At block 706, the sleeve is provided onto the bushing. The sleeves 402 may be disposed onto the bushing 204 using any variety of mechanisms and/or elements to hold the sleeves 402 in place. In some cases, press fitting may be used to press fit the sleeves 402 onto the bushing 204. In these cases, the sleeves may be dimensionally controlled (e.g., the diameter of the insert 404) such that when press fit into the bushing 204, there is enough frictional hold to keep the sleeves 402 securely held within the bushing 204. In other cases, brazing, soldering, and/or welding may be used to hold the sleeves 402 in place within the bushing 204. For example, the insert 404 and/or the inner ring surface 406 may be soldered within the bushing 204 using any suitable material, such as tin-based solder, or the like. In yet other cases, epoxies and/or glues may be used to hold the sleeves 402 within the bushing 204.

It should be noted that some of the operations of method 700 may be performed out of the order presented, with additional elements, and/or without some elements. Some of the operations of method 700 may further take place substantially concurrently and, therefore, may conclude in an order different from the order of operations shown above.

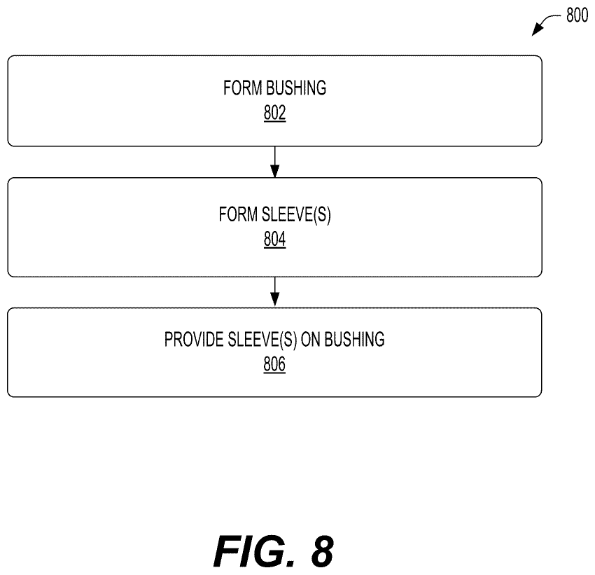

FIG. 8 is a flow diagram depicting an example method 800 for providing a sleeve 402 on a bushing 204, according to examples of the disclosure. At block 802, the bushing 204 may be formed. The bushing 204 may be formed in a manner similar to how the sleeve 402 is formed prior to coating. The bushing may be cast or otherwise formed with steel, machined, and then subject any suitable hardening process.

At block 804, the sleeves may be formed. The formation of the sleeves 402 may be substantially similar to the processes of blocks 702 and 704 of method 700 of FIG. 7, as discussed herein. At block 806, the sleeves are provided onto the bushing. The inserts 404 of the sleeves 402 may be inserted into the bore of the bushing 204. The description of providing the sleeves 402 onto the bushing may be substantially similar to the description of block 706 of method 700 of FIG. 7, as discussed herein.

It should be noted that some of the operations of method 800 may be performed out of the order presented, with additional elements, and/or without some elements. Some of the operations of method 800 may further take place substantially concurrently and, therefore, may conclude in an order different from the order of operations shown above.

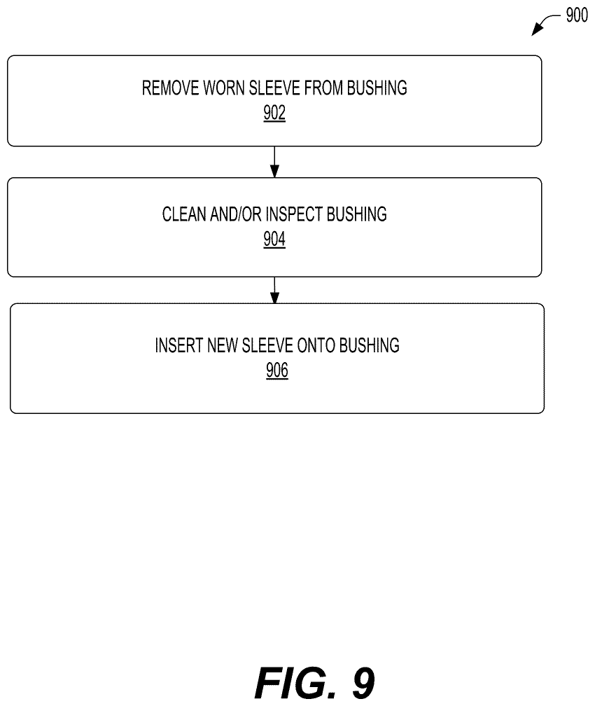

FIG. 9 is a flow diagram depicting an example method 900 for replacing a sleeve on a bushing, according to examples of the disclosure. At block 902, a worn sleeve may be removed from the bushing. The worn sleeve may be pried out of the bushing. If the sleeve 402 was soldered or brazed, it may need to be heated to be removed from the bushing 204. At block 904, the bushing may be cleaned and/or inspected. The inspection may be visual and/or dimensional. For example, if the bushing 204 is damaged, then it may not be possible to swap the sleeve 402. The bushing 204 may be cleaned using any suitable solvent (e.g., water) and/or mechanical processes (e.g., brush scrubbing). At block 906, a new sleeve may be inserted into the bushing. The new sleeve 402 may be inserted into the bushing 204 in a manner similar to the description of block 706 of method 700 of FIG. 7, as discussed herein.

It should be noted that some of the operations of method 900 may be performed out of the order presented, with additional elements, and/or without some elements. Some of the operations of method 900 may further take place substantially concurrently and, therefore, may conclude in an order different from the order of operations shown above.

### INDUSTRIAL APPLICABILITY

The present disclosure describes systems, apparatus, and methods for increased wear tolerant and tough components, such as components for track-type machines 100. These improved components may include bushings 204 used in track chain assemblies 106 of machines 100, where the bushing 204 is protected by one or more sleeves 402. The sleeves 402, as disclosed herein, may be disposed on either end of the bushing 204 to protect the bushing from wear and tear and from galling issues. The sleeves provide a bulk material with an optional hard coating thereon, such as hard Cr, SiC, HVAF deposited coatings, HVOF coatings, or the like. With improved wear resistance from the sleeves, the bushing can be formed to retain its toughness. Although the sleeves 402 and the procedures to from the sleeves 402 are discussed in the context of track-type machines 100 and undercarriages 102 of those track-type machines, it should be appreciated that the sleeves 402 and the mechanisms to form the same are applicable across a wide array of mechanical systems, such as any mechanical system that can benefit from improved wear resistance of bushings and/or other parts.

As a result of the systems, apparatus, and methods described herein, consumable parts of machines 100, such as bushings 204 may have a greater lifetime. For example, the track bushings 204 described herein may have greater service lifetime than traditional bushings 204 that are not formed by the mechanisms described herein. In some cases, the bushings 204 disclosed herein may also be reworked to replace the consumable sleeves 402 to provide even longer service lifetimes of the bushings 204. In some cases, the bushings 204 and/or other components may allow for a 25% to 400%, or more, improvement in the wear lifetime of consumable parts of track-type machines 100. This reduces field downtime, reduces the frequency of servicing and maintenance, and overall reduces the cost of heavy equipment, such as track-type machines 100. The improved reliability and reduced field-level downtime also improves the user experience such that the machine 100 can be devoted to its intended purpose for longer times and for an overall greater percentage of its lifetime. Improved machine 100 uptime and reduced scheduled maintenance may allow for more efficient deployment of resources (e.g., fewer, but more reliable machines 100 at a construction site). Thus, the technologies disclosed herein improve the efficiency of project resources (e.g., construction resources, mining resources, etc.), provide greater uptime of project resources, and improves the financial performance of project resources.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A track chain assembly, comprising:
a bushing having a substantially annular shape with an outer surface and an inner surface opposing the outer surface and defining a bore of the bushing, the bushing extending from a first end ring to an opposing second end ring; and
a sleeve having an insert and a ring portion disposed substantially perpendicularly to the insert, the ring portion having an inner ring surface and an outer ring surface opposing the inner ring surface, wherein:
the sleeve has a coating over a bulk region, and
the sleeve is disposed on the bushing such that the insert of the sleeve is in contact with the inner surface of the bushing and the inner ring surface of the sleeve is in contact with at least one of the first end ring or the second end ring.

2. The track chain assembly of claim 1, wherein the sleeve further includes a wrap portion substantially perpendicular to the ring portion of the bushing and substantially parallel with the insert, wherein the wrap portion is in contact with the outer surface of the bushing.

3. The track chain assembly of claim 1, further comprising:
a second bushing having a substantially annular shape; and
a second sleeve provided on the second bushing.

4. The track chain assembly of claim 1, wherein the coating has a thickness in a range of about 3 microns (μm) to about 200 μm.

5. The track chain assembly of claim 1, wherein the coating has a coefficient of static friction less than the bulk region.

6. The track chain assembly of claim 1, wherein the coating is harder than the bulk region.

7. The track chain assembly of claim 1, wherein the coating is harder than the bushing.

8. The track chain assembly of claim 1, wherein the coating includes trivalent chromium.

9. The track chain assembly of claim 1, wherein the coating includes tungsten carbide.

10. The track chain assembly of claim 1, wherein the coating has a hardness greater than 1100 Vickers.

11. A method, comprising:
forming a bushing having a substantially annular shape with an outer surface and an inner surface opposing the outer surface and defining a bore of the bushing, the bushing extending from a first end ring to an opposing second end ring;
forming a rough sleeve having an insert and a ring portion disposed substantially perpendicularly to the insert;
depositing a coating onto the rough sleeve to form a sleeve; and
inserting the sleeve into the bore of the bushing, such that the insert is in contact with a portion of the inner surface of the bushing and the ring portion of the sleeve is in contact with at least one of the first end ring or the second end ring of the bushing.

12. The method of claim 11, further comprising:
forming a second rough sleeve;
depositing a second coating onto the second rough sleeve to form a second sleeve; and
inserting the second sleeve into the bore of the bushing.

13. The method of claim 11, wherein depositing a coating onto the rough sleeve comprises:
electroplating chromium onto the rough sleeve.

14. The method of claim 11, wherein depositing a coating onto the rough sleeve comprises:
depositing tungsten carbide (WC) using at least one of a high velocity air fuel (HVAF) process or a high velocity oxygen fuel (HVOF) process.

15. The method of claim 11, further comprising:
heating the rough sleeve above 800° C.; and
quenching the rough sleeve.

16. The method of claim 11, wherein the coating has a hardness exceeding 1100 Vickers.

17. The method of claim 11, further comprising:
removing the sleeve from the bushing;
forming a second sleeve; and
inserting the second sleeve into the bore of the bushing.

18. A machine, comprising:
a bushing having a substantially annular shape with an outer surface and an inner surface opposing the outer surface and defining a bore of the bushing, the bushing extending from a first end ring to an opposing second end ring;
a first sleeve having a first insert and a first ring portion disposed substantially perpendicularly to the first insert, the first ring portion having a first inner ring surface and a first outer ring surface opposing the first inner ring surface; and
a second sleeve having a second insert and a second ring portion disposed substantially perpendicularly to the second insert, the second ring portion having a second inner ring surface and a second outer ring surface opposing the second inner ring surface, wherein:
the first sleeve is disposed on the bushing such that the first insert of the first sleeve is in contact with the inner surface of the bushing and the first inner ring surface of the first sleeve is in contact with the first end ring, and
the second sleeve is disposed on the bushing such that the second insert of the second sleeve is in contact with the inner surface of the bushing and the second inner ring surface of the second sleeve is in contact with the second end ring.

19. The machine of claim 18, wherein the first sleeve has a coating with a hardness of at least 1100 Vickers.

20. The machine of claim 18, wherein the first sleeve includes electroplated chromium.
